(19) United States
(12) Patent Application Publication
(10) Pub. No.: US 2010/0259920 A1
(43) Pub. Date: Oct. 14, 2010

(54) LIGHT EMITTING APPARATUS

(75) Inventor: CHUNG-JYH LIN, Tainan County (TW)

Correspondence Address: Flash Intellectual Property, Inc.;Attn. Cheng-Ju Chiang, P.O. Box 766, Chino, CA, 91708, US

(73) Assignee: Aussmak Optoelectronics Corp., YongKang City (TW)

(21) Appl. No.: 12/754,600

(22) Filed: Apr. 5, 2010

(30) Foreign Application Priority Data
Apr. 8, 2009 (TW) 098111673

(51) Int. Cl. G02F 1/13357; F21S 4/00

(52) U.S. Cl. 362/97.1; 362/249.02

(57) ABSTRACT

A light emitting apparatus includes at least one first substrate, a plurality of light emitting units and a partition structure. The light emitting units are disposed in two-dimension array on the first substrate. Each light emitting unit has at least one light emitting diode (LED) die. The LED die is disposed on the first substrate by wire bonding or flip-chip bonding. The partition structure is disposed correspondingly around each light emitting unit.

### CROSS REFERENCE TO RELATED APPLICATIONS

This Non-provisional application claims priority under 35 U.S.C. §119(a) on Patent Application No(s). 098111673 filed in Taiwan, Republic of China on Apr. 8, 2009, the entire contents of which are hereby incorporated by reference.

### BACKGROUND OF THE INVENTION

1. Field of Invention

The invention relates to a light emitting apparatus and, in particular, to a light emitting apparatus having a plurality of light emitting diode dies.

2. Related Art

Since light emitting diodes (LED) have been commercialized, they are widely applied to various appliances in our daily life, such as household appliances, indicator lights and light sources, due to their advantages like long lifespan, less power consumption and less heat generated. Recently, with request of multicolor and high brightness, LEDs are further applied to outdoor display apparatuses, such as large outdoor billboards and traffic lights.

As shown in FIG. 1, a conventional light emitting apparatus 1 includes a circuit board 11, a plurality of LEDs 12 and a connector 13. The LEDs 12 are disposed on the circuit board 11. The connector 13 disposed at the edge of the circuit board 11 is electrically connected with other electronic devices such as another circuit board by plural wires 131, or transmits driving signals through the wires 131 to the circuit board 11 for driving the LEDs to emit light.

However, because the wires 131 go around the edge of the circuit board 11, the light emitting apparatus 1 has an undesired appearance. Besides, if the light emitting apparatus 1 is used as a display apparatus, the intervals of the LEDs 12 can not be shortened any more because the LEDs 12 have been packaged, and therefore DPI (dots per inch) of the light emitting apparatus 1 can not be effectively increased.

Therefore, it is an important subject to provide a light emitting apparatus that is configured with an innovative structure to enhance display quality.

### SUMMARY OF THE INVENTION

In view of the foregoing, an object of the invention is to provide a light emitting apparatus that can enhance display quality in an innovative structure.

To achieve the above, a light emitting apparatus according to the invention includes at least one first substrate, a plurality of light emitting units and a partition structure. The light emitting units are disposed in two-dimension array on the first substrate. Each of the light emitting units has at least one light emitting diode(LED) die. The LED die is disposed on the first substrate by wire bonding or flip-chip bonding. The partition structure is disposed around each of the light emitting units correspondingly.

To achieve the above, another light emitting apparatus according to the invention includes at least a first substrate, a plurality of light emitting units and a partition structure. The first substrate has a substrate body and a patterned layer that is disposed on the substrate body. The light emitting units are disposed in two-dimension array on the first substrate. Each of the light emitting units has at least an LED die. The partition structure is disposed around each of the light emitting units and aligned with the patterned layer. Adhesion between the partition structure and the patterned layer is greater than that between the partition structure and the substrate body.

As mentioned above, the light emitting apparatus of the invention includes a plurality of LED dies directly disposed on the first substrate by wire bonding or flip-chip bonding, so intervals between the LED dies can be shortened more than the prior art and DPI of the display apparatus can be increased greatly to enhance display quality. Furthermore, the light emitting apparatus of the invention includes a partition structure that is disposed around each of the light emitting units, so if the light emitting apparatus is used as a display apparatus, the light emitting units will not be affected mutually by the light emitted from them to prevent crosstalk. Besides, if the light emitting apparatus is used as a backlight module, the partition structure can be served as a blocking structure to block the package material applied to the LED dies, thereby simplifying manufacturing process and reducing the cost.

In addition, because the adhesion between the partition structure and the patterned layer is greater than that between the partition structure and the substrate body, the partition structure can be aligned with the patterned layer by a self-alignment effect to greatly enhance efficiency of the manufacturing process and reduce the cost.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic view of a conventional light emitting apparatus;

FIG. 2 is a schematic view of a light emitting apparatus according to the first embodiment of the invention;

FIGS. 3A and 3D are schematic diagrams showing various aspects of the light emitting apparatus of the first embodiment;

FIG. 4A is a schematic sectional view of a light emitting apparatus of the second embodiment of the invention, and FIG. 4B is a top view schematically showing a portion of the first substrate and the components thereon of the second embodiment;

FIG. 5 is a schematic sectional view of a light emitting apparatus of the third embodiment of the invention; and

FIG. 6A is a schematic top view of a light emitting apparatus of the fourth embodiment of the invention, and FIG. 6B is a schematic view showing an enlargement of the joint of the first substrates of the light emitting apparatus of the fourth embodiment.

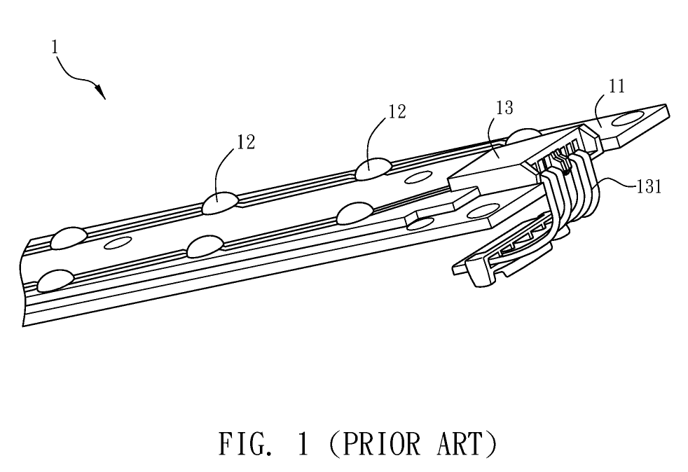

### DETAILED DESCRIPTION OF THE INVENTION

The present invention will be apparent from the following detailed description, which proceeds with reference to the accompanying drawings, wherein the same references relate to the same elements.

### First Embodiment

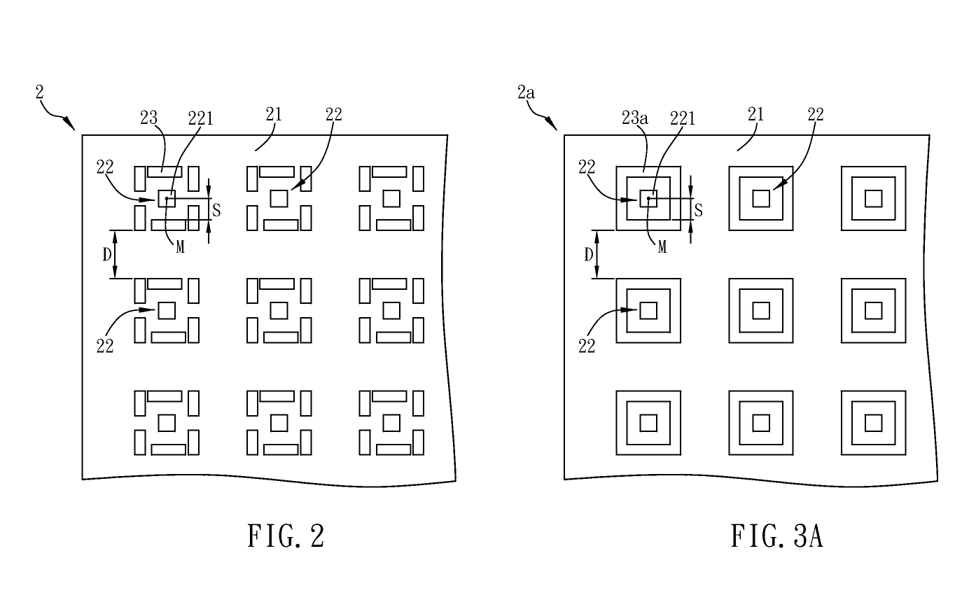

FIG. 2 is a top view of a light emitting apparatus 2 according to the first embedment of the invention. As shown in FIG. 2, the light emitting apparatus 2 can be a display apparatus, a traffic light, a lighting apparatus, a light bar or a backlight module, for example. The light emitting apparatus 2 includes at least a first substrate 21, a plurality of light emitting units 22 and a partition structure 23.

The first substrate 21 can be made of glass, sapphire, quartz, ceramics, fiberglass, resin, metal, or polymer for example. The material of the first substrate 21 is not limited, and here the first substrate 21 is a printed circuit board (PCB) for example.

The light emitting units 22 are disposed in two-dimension array on the first substrate 21. Each of the light emitting units 22 has at least a light emitting diode (LED) die 221 that is disposed on the first substrate 21 by wire bonding or flip-chip bonding. For instance, each light emitting unit 22 of the embodiment has an LED die 221 that is disposed on the first substrate 21 by flip-chip bonding. The LED die 221 can emit, for example, red light, green light, blue light, blue-green light, or other visible light, and the light emitting unit 22 can emit monochromatic light or mixed light (such as white light). The light emitting unit 22 can be a light bar which consists of a strip-like circuit board and a plurality of LED dies that are packaged and disposed on the strip-like circuit board. If the light emitting unit 22 is a light bar, the light bar is disposed on the first substrate 21.

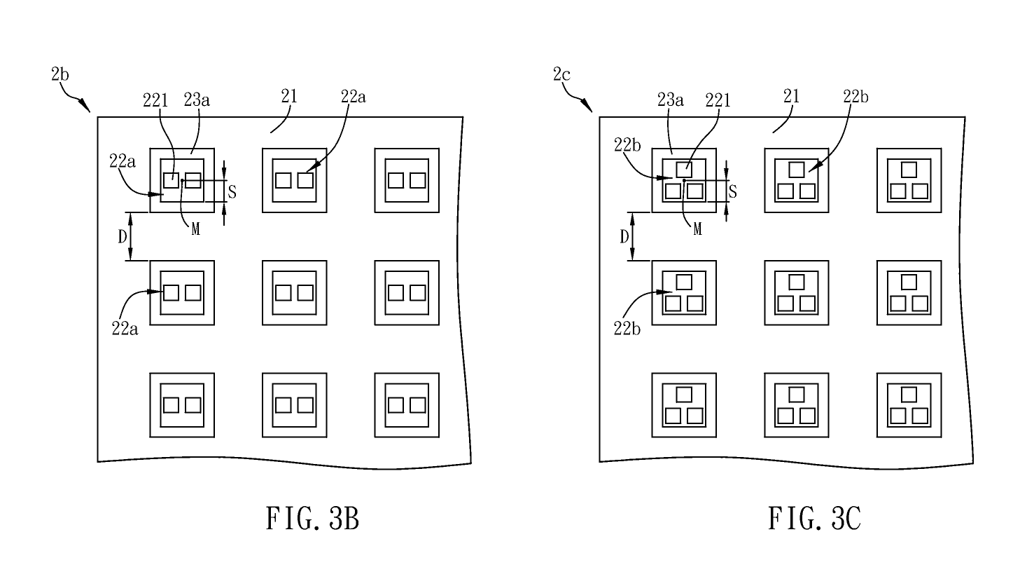

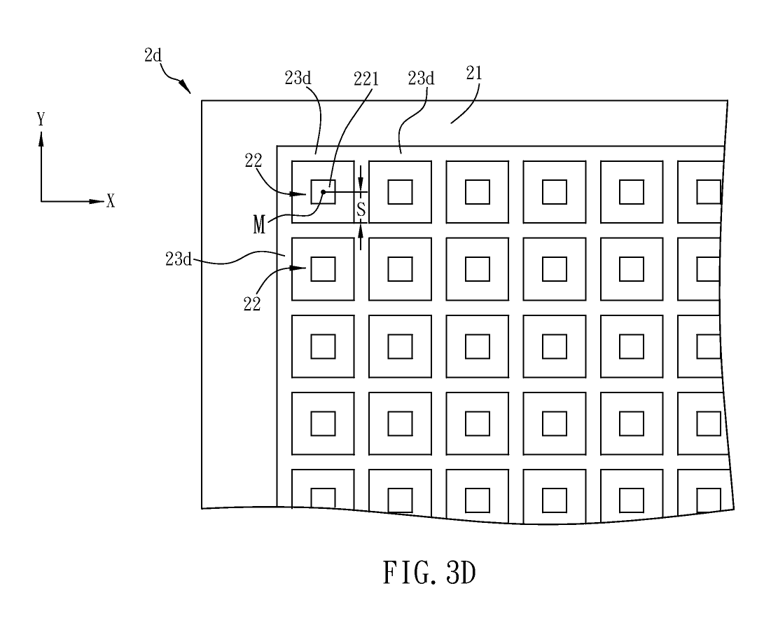

FIG. 3A is a schematic top view showing the light emitting apparatus 2a of another aspect of the embodiment. As shown in FIG. 2 and FIG. 3A, the partition structures 23, 23a are disposed on the first substrate 21, and they can be disposed around each of the light emitting units 22 discretely (see FIG. 2) or continuously (see FIGS. 3A to 3C). The continuous partition structure 23a has a closed contour, and can be shaped like a square, a rectangle, a circle, a triangle, a hexagon or a polygon. The partition structure 23a here is shaped like a square for example. Besides, a shortest distance S is from the partition structure 23, 23a, to the central position M of the light emitting unit 22, and the total length of the partition structure 23, 23a is larger than threefold the shortest distance S.

The central position M practically can represent the center-of-gravity position of the LED dies 221 arranged on the first substrate 21. If the light emitting unit 22 only has a single LED die 221, the central position M represents the center-of-gravity position of the LED die 221. If the light emitting unit 22 has two LED dies 221 as shown in FIG. 2B, the central position M represents the center-of-gravity position of the LED dies 221, that is between the LED dies 221. If the light emitting unit 22 has three LED dies 221 as shown in FIG. 2C, the central position M represents the center-of-gravity position of the LED dies 221, that is also between the LED dies 221.

Referring again to FIG. 2, the partition structures 23 corresponding to two adjacent light emitting units 22 are spaced with a gap D. Of course in another case, the partition structures 23 corresponding to two adjacent light emitting units 22 can be connected together without the gap. As shown in FIG. 3D, two adjacent partition structures 23d of the light emitting apparatus 2d can connect with each other in the X direction and/or the Y direction. In the case of that two adjacent partition structures 23d connect with each other, the first substrate 21 can contain more light emitting units 22 than the case of that two adjacent partition structures 23d are spaced with the gap. Of course, the above cases can be chosen according to request.

Besides, a height of the partition structure 23 is greater than that of the LED die 221. To take a red LED die as an example, a height of which is about 200 micrometers, and if the red LED die is disposed by wire bonding, a height of the added wire is about 50 micrometers. So, the height of the partition structure 23 needs to exceed 250 micrometers to prevent crosstalk of the light emitted from the light emitting units 22.

The material of the partition structure 23 includes metal, alloy, polymer, plastics, ceramics or glass. The metal mentioned above can be copper or tin for example. The partition structure 23 can be made by injection molding (material can be polymer or plastics for example), ink jet printing (material can be polymer for example), or co-firing (material can be ceramics or glass for example) after screen printing.

Therefore, the light emitting apparatus 2 includes a plurality of LED dies 221 directly disposed on the first substrate 21 by wire bonding or flip-chip bonding, so the gaps between the light emitting units 22 can be shortened more than the prior art and DPI of the display apparatus can be increased greatly to enhance display quality. Accordingly, the pixel size can be even smaller than 3 mm. Furthermore, the light emitting apparatus 2 further includes a partition structure 23 that is disposed around each light emitting unit 22, so if the light emitting apparatus 2 is used as a display apparatus, the light emitting units 22 will not be affected mutually by the light emitted from them to prevent the problem of color shift. Besides, if the light emitting apparatus 2 is used as a backlight module, the partition structure 23 can be served as a blocking structure to block the package material applied to the LED dies, thereby simplifying manufacturing process and reducing the cost.

### Second Embodiment

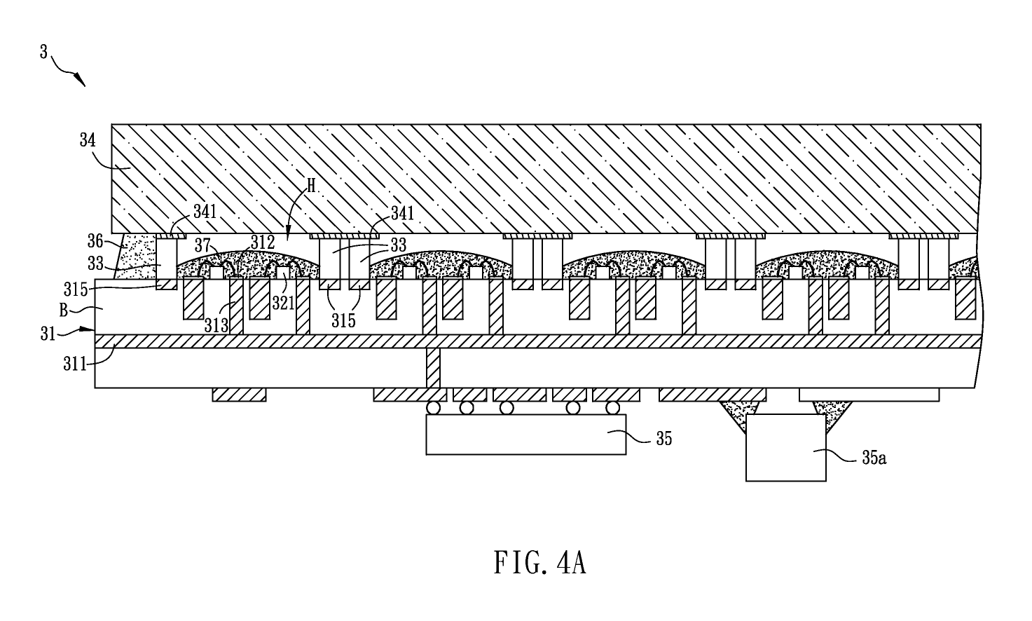

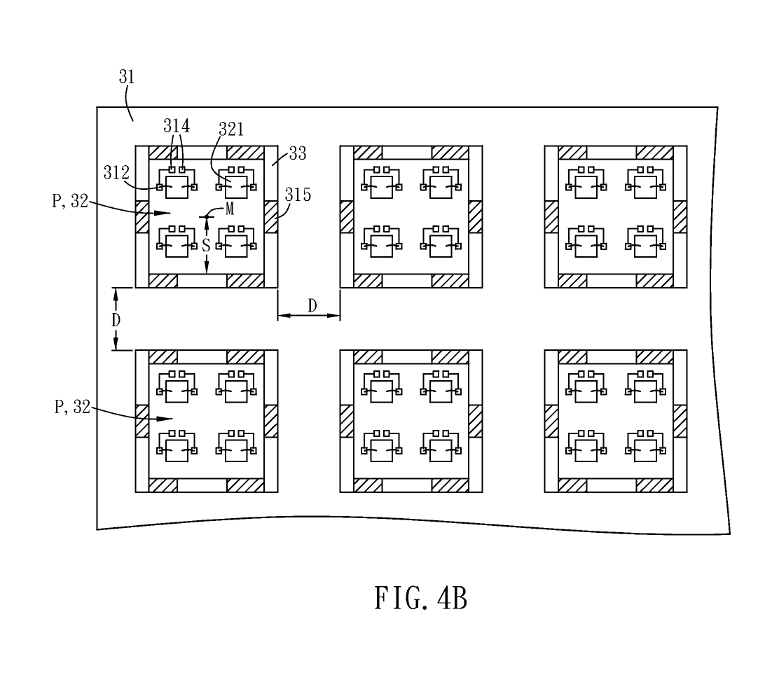

FIG. 4A is a schematic sectional view of a light emitting apparatus 3 of the second embodiment, and FIG. 4B is a top view schematically showing a portion of the first substrate 31 and the components thereon. The light emitting apparatus 3 includes a first substrate 31, a plurality of light emitting units 32, a partition structure 33 and a second substrate 34. The second substrate 34 is disposed opposite to the first substrate 31 to protect the light emitting units 32. Each of the light emitting units 32 has a plurality of LED dies 321. The light emitting apparatus 3 of the embodiment is a display apparatus for example.

In the embodiment, the LED dies 321 are disposed on the first substrate 31 by wire bonding for example. The LED dies 321 can respectively emit, for example, red light, green light, blue light, blue-green light, or other visible light according to request. Besides, a fluorescent layer can be disposed on the first substrate 31 and/or the second substrate 34 to generate colored lights in demand. For the light emitting apparatus 3 as a display apparatus, the light emitting units 32 are corresponding to a plurality of pixels P respectively. Each of the light emitting units 32 can include three LED dies 321 which emit red light, blue light and green light respectively to generate mixed white light. Or, each of the light emitting units 32 can include four LED dies 321 which consist of two red LED dies 321, a green LED die 321 and a blue LED die 321. Because the LED die 321 is smaller, the light emitting unit 32 can be greatly reduced in size as well as the pixel. For instance, the size of the pixel reduced can be from 0.5 mm to 1 mm, so DPI can be greatly increased.

The second substrate 34 can be made of glass, sapphire, quartz, ceramics, fiberglass, resin, polymer or other transparent material. Here the second substrate 34 is a glass substrate for example. Thereby, the light emitted from the light emitting units 32 can be ejected through the second substrate 34, and that is, observers can see images displayed by the light emitting apparatus 3 through the outlet side of the second substrate 34.

The second substrate 34 can have a shielding layer 341 that can be made of photoresist, polymer, ceramics or metal. The shielding layer 341 is disposed at an upright position of the partition structure 33, lest the light emitted by the light emitting unit 32 is shielded. The shielding layer 341 has a plurality of openings H corresponding to the light emitting units 32 respectively. The shielding layer 341 can be served as a black matrix (BM) layer, one side of which connecting to the second substrate 34 can be black, and the other side facing the first substrate 31 can be white. Thereby, the black side of the shielding layer 341 can absorb the light from the outside and entering through the second substrate 34, while the white side of the shielding layer 341 can reflect the light emitted from the LED die 321 back to the region of the light emitting unit 32 so that the light emitted by the light emitting unit 32 can be all directed to the opening H. Accordingly, contrast ratio of the image displayed by the light emitting apparatus 3 is improved. To be noted, the shielding layer in another case can be disposed to the first substrate 31 and located at the outside of the partition structure 33 opposite to the light emitting unit 32.

As shown in FIG. 4B, a shortest distance S is from the partition structure 33 to the central position M, and the total length of the partition structure 33 is larger than threefold the shortest distance S. In this case, the light emitting unit has four LED dies 321, so the central position M representing the center-of-gravity position is between the LED dies 321. Besides, the partition structures 33 corresponding to two adjacent light emitting units 32 are spaced with a gap D. To be noted, the partition structure 33 can be disposed on the first substrate 31 as shown in the embodiment; otherwise, the partition structure 33 can be disposed on the second substrate 34 alternatively.

The first substrate 31 can have a circuit layer 311 and a plurality connecting pads 312. The first substrate 31 can be a single-layer circuit board or a multi-layer circuit board, and here a multi-layer circuit board is instanced as the first substrate 31. The circuit layers 311 can be electrically connected to each other by conductive holes (via) 313. The connecting pads can be disposed on the first substrate 31 through screen printing. The LED dies 321 can be first electrically connected with the connecting pads 312, and then electrically connected with the circuit layer 311 by conductive holes 313.

As shown in FIG. 4B, the first substrate 31 can further have a plurality of repairing pads 314 which are disposed corresponding to the connecting pads 312 respectively. When one of the LED dies 321 is damaged, the two repairing pads 314 corresponding to the LED die can be short-circuited. Therefore, the light emitting apparatus 3 that has the LED dies in series will not be incapable of emitting light due to a LED die damaged, to save the cost and avoid waste of material.

In addition, the first substrate 31 can further have a patterned layer 315. The partition structure 33 is disposed on the patterned layer 315 that is made of copper at least. The patterned layer 315 can be disposed at the same layer as or different layer from the circuit layer 311. The patterned layer 315 here is disposed at different layer from the circuit layer 311 for instance. Besides, the patterned layer 315 is disposed to a substrate body B of the first substrate 31. The patterned layer 315 can be disposed on the substrate body B or inside the substrate body B, and here for instance, the patterned layer 315 is disposed at the top surface of the substrate body B.

When the partition structure 33, that is made of tin for example, is disposed on the patterned layer 315 made of copper, inter-metal compound (IMC) such as Cu₃Sn or Cu₆Sn₅ will be formed between the patterned layer 315 and the partition structure 33. Accordingly, when a tin paste that is screen-printed on the first substrate 31 to make the partition structure 33 reflows, the tin paste will be self-aligned with the patterned layer 315 by forming IMC. Therefore, by the patterned layer 315, the partition structure 33 can be formed around the light emitting units 32 with self-alignment more accurately than the prior art in which the partition structure 33 is screen-printed with a great inaccuracy and thus can not be disposed around the LED dies 321 accurately.

To be noted, the materials of the partition structure 33 and the patterned layer 315 mentioned above are just for instance, and the materials of both are not limited. Widely speaking, the partition structure 33 can be disposed on the patterned layer 315 by self-alignment because the adhesion between the partition structure 33 and the patterned layer 315 is greater than that between the partition structure 33 and the substrate body B (or the material around the patterned layer 315), so that the partition structure 33 adheres to the patterned layer 315 instead of spreading to the material around the patterned layer 315. To take FR-4 circuit board as the first substrate 31 for instance, FR-4 circuit board mainly consists of glass fiber, epoxy that is mixed with glass fiber, and insulating green paint that is printed on the top surface of the FR-4 circuit board. In this case, the adhesion between the partition structure 33 and the patterned layer 315 is greater than that between the partition structure 33 and glass fiber, or epoxy, or green paint, so that the partition structure 33 adheres to the patterned layer 315.

Besides, cohesion of the partition structure 33 of the embodiment can be smaller than the adhesion between the partition structure 33 and the patterned layer 315, so that the partition structure 33 can not form drops and can thus adheres to the patterned layer 315.

By making adhesion between the partition structure and the patterned layer greater than that between the partition structure and the substrate body, the partition structure can be self-aligned with the patterned layer to greatly enhance efficiency of manufacturing process and reduce the cost.

To be noted, in general the process of metal finish can be performed on the outer circuit layer or the patterned layer 315 of the PCB by, for example, Sn, Ag, Ni/Au, Ni/Pd/Au, or organic solderability preservative (OSP), to prevent the outer circuit layer or the patterned layer 315 from oxidizing as a result of longer exposure to the air.

The light emitting apparatus 3 can further include at least a driving device 35, a connecting adhesive 36, and a packaging material 37, for example.

The driving device 35, for driving the LED dies 321, is disposed on the first substrate 31 and located at the opposite side of the LED dies 321. The driving device 35 includes a driver IC for example. If the driving device 35 is a die, it can be disposed on the first substrate 31 by wire bonding or flip-chip bonding. If the driving device 35 is a package or a surface-mounted device (SMD), it can be disposed on the first substrate 31 by surface-mount technology (SMT). As shown in FIG. 4A, for instance, the driving device 35 is disposed by flip-chip bonding and another driving device 35a is disposed by SMT.

The connecting adhesive 36 can be also called sealant that is disposed between the first and second substrates 31, 34 and connects the first substrate 31 and the second substrate 34. The connecting adhesive 36 can be, for example, underfill adhesive, that can permeate between the substrates 31, 34 by capillarity. Alternatively, the connecting adhesive 36 can be applied to the first substrate 31 or the second substrate 34 first, and then the substrates 31, 34 can adhere to each other.

The packaging material 37 covers at least an LED die 321, and for instance here, the packaging material 37 covers all LED dies 321. The packaging material 37 can cover each of the LED dies 321 of each light emitting unit 32 discretely by dispensing, or cover all LED dies 321 of each light emitting unit 32 continuously. Besides the packaging material 37, a liquid can be filled between the substrates 31, 34 to improve thermal conductivity of the light emitting units 32. The liquid can consist of material with high thermal conductivity. The material of the liquid can be chosen in consideration of insulating property, corrosion property, solidification point, and thermal expansion coefficient. The liquid can be the oil type or the solvent type which can be chosen according to request, wherein the oil type is such as mineral oil, silicon oil, and glycerin, and the solvent type is such as mesitylene.

### Third Embodiment

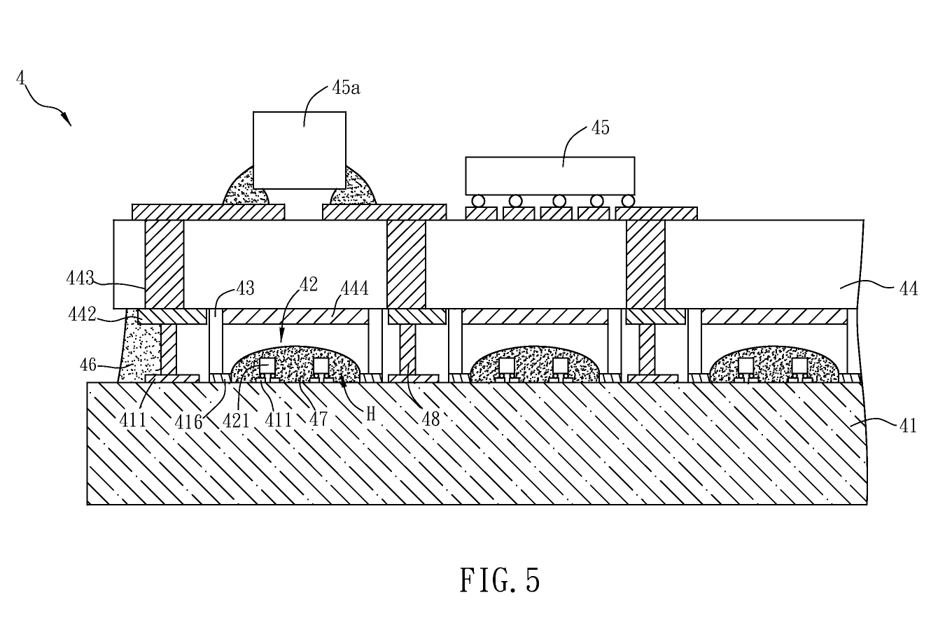

FIG. 5 is a schematic sectional view of a light emitting apparatus 4 according to the third embodiment of the invention. As shown in FIG. 5, the light emitting apparatus 4 includes a first substrate 41, a plurality of light emitting units 42, a partition structure 43, a second substrate 44, a driving device 45, a connecting adhesive 46 and a packaging material 47. The first substrate 41 is glass substrate for example. The material of the second substrate 44 is not limited, and for instance, the second substrate 44 is a PCB. The LED dies 421 of the light emitting unit 42 are disposed on the first substrate 41 by flip-chip bonding for example.

In the embodiment, the partition structure 43 is disposed on the second substrate 44. The first substrate 41 has a shielding layer 416 that is disposed at the same side as the LED dies 421 of the first substrate 41 and located at an upright position of the partition structure 43. The shielding layer 416 has a plurality of openings H that are corresponding to the light emitting units 42 respectively. The shielding layer 416 can be made of the same material as the shielding layer 341 of the above embodiment, so detailed descriptions are omitted here.

The second substrate 44 can further have a reflective layer 444 that is disposed at a side facing the first substrate 41 to reflect the light emitted from the LED dies 421. The material of the reflective layer 444 can include metal, metallic oxide, alloy or white paint. Accordingly, one portion of the light emitted by the LED dies 421 will directly pass through the first substrate 41, and another portion of the light will be reflected by the reflective layer 444 to pass through the first substrate 41. In this case, the first substrate 41 is served as the outlet side of the light of the light emitting apparatus 4, and observers can see images displayed by the light emitting apparatus 4 through the first substrate 41.

Furthermore, the driving devices 45, 45a of the embodiment are disposed at the far side of the second substrate 44 from the first substrate 41. In another case, the driving devices 45, 45a can be disposed at the side, facing the first substrate 41, of the second substrate 44. The connecting adhesive 46 is disposed between the first and second substrates 41, 44 to adhere to the substrates 41, 44. The packaging material 47 covers all LED dies 421 for instance. Besides the packaging material 47, a liquid can be filled between the substrates 41, 44 to improve thermal conductivity of the light emitting units 42. Because the partition structure 43, the connecting adhesive 46 and the packaging material 47 can the features of the same elements mentioned in the above embodiments, detailed descriptions are omitted here.

Because the driving devices 45, 45a and the LED dies 421 are disposed at different substrates, to make the driving devices 45, 45a electrically connect to the LED dies 421, the light emitting apparatus 4 further includes a conductive element 48 that is disposed between the first substrate 41 and the second substrate 44 and electrically connects to the first substrate 41 and the second substrate 44.

The conductive element 48 can be made as various types, such as conductive rod, conductive ball or conductive adhesive. The material of the conductive element 48 is not limited in the embodiment, and it can be made of metal, alloy or semiconductor material, such as copper, aluminum or doped silicon. If the conductive element 48 is made as a conductive rod, it can be disposed on the first substrate 41 in the process in which the LED dies 421 are disposed on the first substrate 41. Besides, an adhesive with conductivity is disposed to the joint of the conductive element 48 and the first substrate 41 and the joint of the conductive element 48 and the second substrate 44, to make the conductive element 48 adhere to the substrates 41, 44. If the conductive element 48 is made as a conductive adhesive, it can be disposed on the first substrate 41 by screen printing.

In the embodiment, a plurality of connecting pads 442 are disposed at a side, facing the first substrate 41, of the second substrate 44 to electrically connect to the conductive element 48. The connecting pads 442 can be made of tin paste that is formed on the second substrate 44 by screen printing. Accordingly, the driving element 45 can be electrically connected with the LED dies 421 through the conductive hole 443, the connecting pad 442, the conductive element 48 and the circuit layer 411 sequentially.

Therefore, by disposing the driving element 45 on the second substrate 44 and using the conductive element 48 to electrically connect the substrates 41, 44, the manufacturing process and the structure of the first substrate 41 can be simplified to reduce the cost and increase efficiency of manufacturing.

### Fourth Embodiment

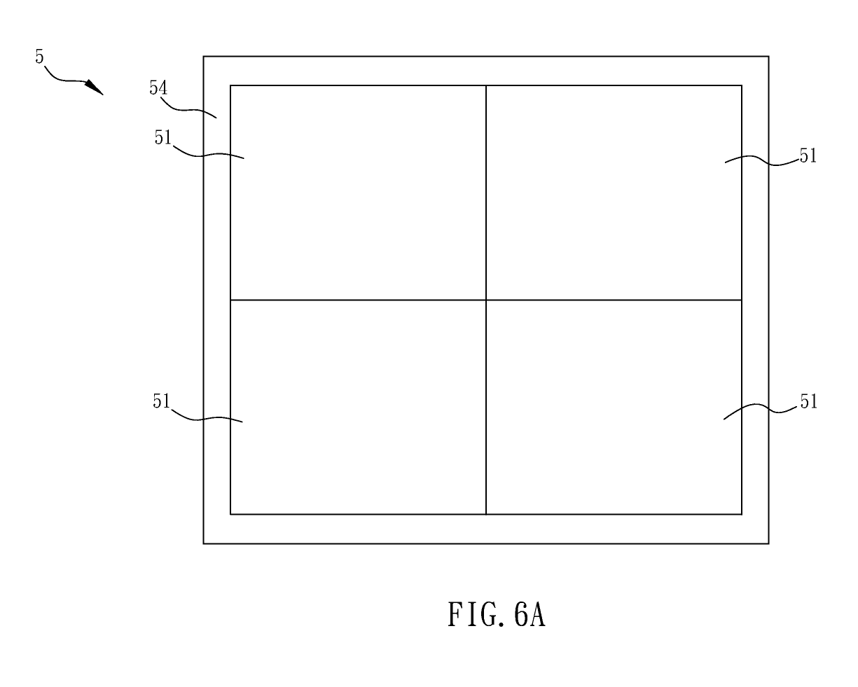

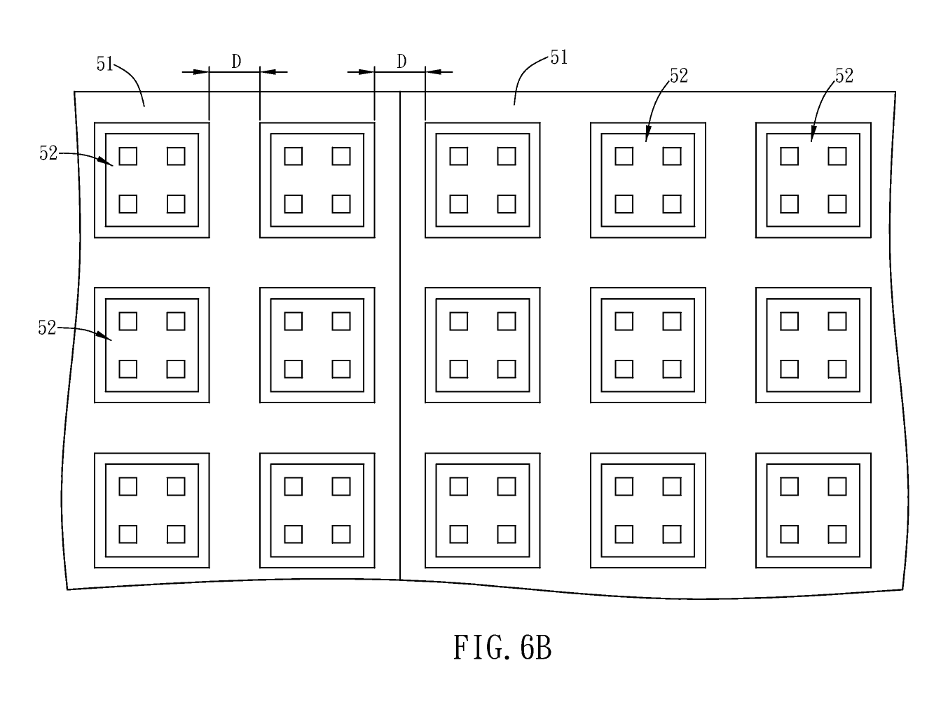

FIG. 6A is a schematic top view of a light emitting apparatus 5 according to the fourth embodiment of the invention, and FIG. 6B is a schematic view showing an enlargement of the joint of the adjacent first substrates 51 of the light emitting apparatus 5. As shown in FIGS. 6A and 6B, the light emitting apparatus 5 includes a plurality of first substrate 51 and a second substrate 54. Each of the first substrates 51 has a plurality of light emitting units 52. Because the first substrate 51 and the second substrate 54 can have the features of the same elements mentioned in the all above embodiments, detailed descriptions are omitted here.

The first substrates 51 can be connected to each other directly or indirectly in a tiling way, to construct a large-scale display apparatus. In the case of the first substrates 51 connected to each other indirectly, the first substrate 51 first can connect to another first substrate 51 by a connecting device (e.g. frame) or through adhering or wedging, and then they are connected to a second substrate 54 to construct the light emitting apparatus 5. In the embodiment, first, a frame can be used to connect the four first substrates 51, or the four first substrates 51 can be attached to a supporting board, and then they are connected to the second substrate 54 to construct a large-scale display apparatus, a lighting apparatus or a backlight module. To be noted, the first substrate 51 here is shaped like a square for example, and besides, it can be shaped like a circle, an ellipse, a polygon or a concave polygon. The supporting board can be made of transparent material or opaque material. Besides, the number of the first substrates 51 is not limited, it can be determined according to request.

In the case of two first substrates 51 connected to each other directly, because no wires exist at the edges of the first substrates 51, there is no gap between the first substrates 51 after they are connected. So the display quality of the light emitting apparatus 5 can be improved. Besides, by disposing the LED dies in the light emitting units 52, the gap D between two light emitting units 52 can be reduced and between 0.3 mm and 1 mm. Furthermore, because no gap exist between adjacent first substrates 51, the two light emitting units 52, closest to each other, of different first substrates 51 can be spaced at the gap D that is the same as the gap D of the adjacent light emitting units 52 on the same first substrate 51. Accordingly, the light emitting units 52 are regularly spaced at the gap D, and the two light emitting units 52, closest to each other, of different first substrates 51 are also spaced at the gap D, so observers can not tell the light emitting apparatus 5 is constructed by connecting several first substrates 51 so as to improve quality of the light emitting apparatus 5.

In the embodiment, the size of the second substrate 54 is more than that of the first substrate 51. Alternatively, if the light emitting apparatus 5 is constructed by a plurality of the second substrates 54 and a plurality of the first substrates 51 which are one-to-one for example, the size of the second substrate 54 needs to be less than that of the first substrate 51 so that the first substrates 51 can connected to each other in a tiling way to construct a large-scale display apparatus, a lighting apparatus or a backlight module. The light emitting apparatus 5 as shown in the embodiment is shaped like several squares connecting together; otherwise, it can be shaped like several strips connecting together or several polygons connecting together.

As mentioned above, the light emitting apparatus of the invention includes a plurality of LED dies directly disposed on the first substrate by wire bonding or flip-chip bonding, so intervals between the LED dies can be shortened more than the prior art and DPI of the display apparatus can be increased greatly to enhance display quality. Furthermore, the light emitting apparatus of the invention includes a partition structure that is disposed around each of the light emitting units, so if the light emitting apparatus is used as a display apparatus, the light emitting units will not be affected mutually by the light emitted from them to prevent crosstalk. Besides, if the light emitting apparatus is used as a backlight module, the partition structure can be served as a blocking structure to block the package material applied to the LED dies, thereby simplifying manufacturing process and reducing the cost. Furthermore, after the first substrates are connected together, adjacent first substrates are connected closely and no gap is caused between them, to enhance competitiveness of the product.

In addition, because adhesion between the partition structure and the patterned layer is greater than that between the partition structure and the substrate body, the partition structure can be aligned with the patterned layer by a self-alignment effect to greatly enhance efficiency of the manufacturing process and reduce the cost.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light emitting apparatus, comprising:
at least a first substrate;
a plurality of light emitting units disposed in two-dimension array on the first substrate, wherein each of the light emitting units has at least a light emitting diode (LED) die disposed on the first substrate by wire bonding or flip-chip bonding; and
a partition structure disposed around each of the light emitting units correspondingly.

2. The light emitting apparatus as recited in claim 1, which is a display apparatus, a lighting apparatus, a backlight module or a light bar.

3. The light emitting apparatus as recited in claim 1, wherein the partition structures corresponding to two adjacent light emitting units are spaced with a gap or connected together.

4. The light emitting apparatus as recited in claim 1, wherein the partition structure is disposed on the first substrate.

5. The light emitting apparatus as recited in claim 1, wherein the partition structure is disposed around each of the light emitting units continuously or discretely.

6. The light emitting apparatus as recited in claim 1, wherein the total length of the partition structure is larger than triple of a shortest distance from the partition structure to the central position of the corresponding light emitting unit.

7. The light emitting apparatus as recited in claim 1, further comprising:
a second substrate disposed opposite to the first substrate.

8. The light emitting apparatus as recited in claim 7, wherein the second substrate has a shielding layer having a plurality of openings corresponding to the light emitting units respectively.

9. The light emitting apparatus as recited in claim 7, further comprising:
a conductive element disposed between the first substrate and the second substrate and electrically connected with the first substrate and the second substrate.

10. The light emitting apparatus as recited in claim 1, wherein the material of the partition structure includes metal, alloy, polymer, plastics, ceramics or glass.

11. The light emitting apparatus as recited in claim 1, wherein the first substrate has a shielding layer disposed at the same side as the LED dies on the first substrate and having a plurality of openings corresponding to the light emitting units respectively.

12. The light emitting apparatus as recited in claim 1, wherein the first substrate has a circuit layer electrically connected with the LED dies.

13. The light emitting apparatus as recited in claim 12, wherein the first substrate further has a patterned layer and the partition layer is disposed on the patterned layer.

14. The light emitting apparatus as recited in claim 13, wherein the material of the patterned layer includes copper.

15. The light emitting apparatus as recited in claim 1, wherein a height of the partition structure is greater than that of the LED die.

16. A light emitting apparatus, comprising:
at least a first substrate having a substrate body and a patterned layer disposed on the substrate body;
a plurality of light emitting units disposed in two-dimension array on the first substrate, wherein each of the light emitting units has at least an LED die; and
a partition structure disposed around each of the light emitting units and aligned with the patterned layer, wherein adhesion between the partition structure and the patterned layer is greater than that between the partition structure and the substrate body.

17. The light emitting apparatus as recited in claim 16, wherein the partition structures corresponding to two adjacent light emitting units are spaced with a gap or connected together.

18. The light emitting apparatus as recited in claim 16, wherein the partition structure is disposed around each of the light emitting units continuously or discretely.

19. The light emitting apparatus as recited in claim 16, wherein the total length of the partition structure is larger than triple of a shortest distance from the partition structure to the central position of the corresponding light emitting unit.

20. The light emitting apparatus as recited in claim 16, wherein the material of the partition structure includes metal, alloy, polymer, plastics, ceramics or glass.
